(19) United States
(12) Patent Application Publication
(10) Pub. No.: US 2010/0205169 A1
(43) Pub. Date: Aug. 12, 2010

(54) SYSTEM AND METHODS FOR PROVIDING CONTENT USING CUSTOMIZED RSS AGGREGATION FEEDS

(75) Inventors: Pramodh D. Narayan, Naperville, IL (US); Sri Ramanathan, Lutz, FL (US); Matthew A. Terry, Dunwoody, GA (US); Matthew B. Trevathan, Kennesaw, GA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INTERNATIONAL BUSINESS MACHINES CORPORATION, Armonk, NY (US)

(21) Appl. No.: 12/366,974

(22) Filed: Feb. 6, 2009

(51) Int. Cl. G06F 15/16; G06F 12/08; G06F 17/30

(52) U.S. Cl. 707/711; 709/217; 711/118; 707/E17.014; 711/E12.017

(57) ABSTRACT

A system and methods are provided for aggregating content and sending the same using customized RSS aggregation feeds. The method is implemented on a computing infrastructure. The method includes indexing items from at least one of multiple RSS sources and non-RSS sources and aggregating two or more of the items from the indexed items associated with one or more user preferences. The method further includes sending an aggregated RSS feed to a user which includes the aggregated two or more of the items associated with the one or more user preferences.

### FIELD OF THE INVENTION

The invention generally relates to providing content using RSS feeds and, in particular, to a system and methods for aggregating content and sending the same using customized RSS aggregation feeds.

### BACKGROUND

Faced with an increasingly difficult challenge in growing both average revenue per user (ARPU) and numbers of subscribers, wireless carriers and content providers are trying to develop a host of new products, services, and business models based on data services. One such service is based on providing content to a user. It is expected that content based services will generate additional business for the carrier as well as the content provider.

For the mobile user as well as the service provider, providing content offers many unique opportunities. For example, content can increase revenue of the service provider, e.g., network carrier, while improving services to end users, e.g., mobile users. Some examples of content may include, for example:
Providing alerts, such as notification of a sale on gas or warning of a traffic jam;
Providing weather reports which are germane to the user; and/or
Providing stock quotes or other business information to the user.

Currently, content providers or service providers of any sort can provide information to the user by the use of Really Simple Syndication (RSS) feeds. RSS is a set of formats for publishing information on the Internet mainly targeted at information that changes frequently such as weather, news, stocks, etc. The most popular RSS format is currently RSS 2.0 and is a dialect of the XMI, 1.0 specification. The feed is comprised of multiple item elements that represent a single unit of information with specified attributes such as title, description, link, etc.

The RSS format and dynamic nature of the information it provides fits well in a feed method of deliver where a user subscribes to an RSS feed to view up to date information. However, each feed a user can subscribe to has a defined category or type of information it provides such as a news feed showing “US Top Stories” from a specific news (content) provider. As the news changes, the contents of the RSS feed changes. Also, when a feed source exists for a user's particular interest, the user can subscribe to the particular feed and receive the latest information. However, if a single feed does not exist for the user's particular interest the user must subscribe to the feeds that best match their interest and sift through extraneous information until they find the required information. This is a time consuming and, at times depending on the amount of information, a daunting task for the user.

Accordingly, there exists a need in the art to overcome the deficiencies and limitations described hereinabove.

### SUMMARY

In a first aspect of the invention, a method is implemented on a computing infrastructure. The method comprises indexing items from at least one of multiple RSS sources and non-RSS sources and aggregating two or more of the items from the indexed items associated with one or more user preferences. The method further comprises sending an aggregated RSS feed to a user which includes the aggregated two or more of the items associated with the one or more user preferences.

In another aspect of the invention, a computer program product comprises a computer usable storage medium having readable program code tangibly embodied in the storage medium. The computer program product is operable to: receive and store user preferences for obtaining content on one or more RSS sources and non-RSS sources; retrieve items from the one or more RSS sources and non-RSS sources; aggregate the items from the one or more RSS sources and non-RSS sources associated with the user preferences; and send an aggregated RSS feed to the user of the aggregated items from the one or more RSS sources and non-RSS sources.

In another aspect of the invention, a system is implemented on a computer infrastructure having at least hardware components or a combination of software components and the hardware components. The system is operable to: store user preferences for obtaining content on one or more RSS sources and non-RSS sources; retrieve items from the one or more RSS sources and non-RSS sources; index the retrieved items; store the index of items for future retrieval; aggregate the indexed items associated with user preferences; and send an aggregated RSS feed to the user of the aggregated indexed items from the one or more RSS sources and non-RSS sources based on the user preferences.

### BRIEF DESCRIPTION OF SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing processes in accordance with the invention;

FIG. 2 is a high level system context for implementing processes in accordance with the invention;

FIG. 3 is a high level schematic diagram showing RSS indexing of multiple of RSS items from RSS and non-RSS sources in accordance with aspects of the present invention;

FIG. 4 is a swim lane diagram showing a process of creating a custom feed in accordance with aspects of the present invention;

FIG. 5 is a swim lane diagram showing a process of accessing a custom feed and built dynamically in accordance with aspects of the present invention; and

FIG. 6 is a swim lane diagram showing a process of reordering search results based on various criteria in accordance with aspects of the present invention.

### DETAILED DESCRIPTION

The invention generally relates to providing content using RSS feeds and, in particular, to a system and methods for aggregating content and sending the same using customized RSS aggregation feeds. More specifically, the system and method of the present invention extends the RSS feed paradigm to deliver information that is dynamic in nature by allowing a user to subscribe to information across multiple RSS feed sources. This allows a user to subscribe to search results and receive new matching information as soon as it becomes available in any one feed. The information is prioritized based on predefined criteria such as, for example, location, blacklist, past history, active rating, and whitelist criteria to name a few.

Advantageously, by implementing the present invention it is possible for a user to subscribe to an RSS feed that is the result of a search for specific information that is retrieved from multiple RSS sources based on the user's criteria. This allows the user to subscribe to a search of RSS feeds instead of subscribing to individual RSS feeds and manually finding the information that pertains to their interest. In embodiments, the system and methods rely on the use of indexing RSS feeds and non-RSS sources and in a unique way providing content to the user based on the index of information. This being the case, there is no requirement for a custom agent on the user's computer except for a common web browser or RSS reader.

In embodiments, the system and method of the present invention indexes both RSS and HTML pages into one system and references the HTML pages as feed material. In embodiments, the system and method of the present looks for RSS tags inside the HTML. This allows the user to create a feed based on search parameters that creates a daily, hourly, weekly feed based off indexed material. The returned feed is a result of the indexed items. Also, by implementing the system and methods of the present invention, as described below, t is possible to, amongst other advantages:
passively exclude information based on the user's passed feed rejections;
passively increase information based on a user's past rates of reading feeds;
actively rate feeds using a sliding scale, which can be used to effect the priority of future feeds containing similar information;
manually add priority to certain feeds;
return or exclude feeds within a list; and/or
prioritize a result feed based on a user's location.

### Exemplary System Environment and Infrastructure

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:
a portable computer diskette,
a hard disk,
a random access memory (RAM),
a read-only memory (ROM),
an erasable programmable read-only memory (EPROM or Flash memory),
a portable compact disc read-only memory (CDROM), and/or
an optical storage device.
   The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer-usable or computer-readable medium may be any medium that can contain, store, communicate, propagate, or transport the program for use by or in connection with the instruction execution system, apparatus, or device. The computer usable program code may be transmitted using any appropriate transmission media via a network.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider).

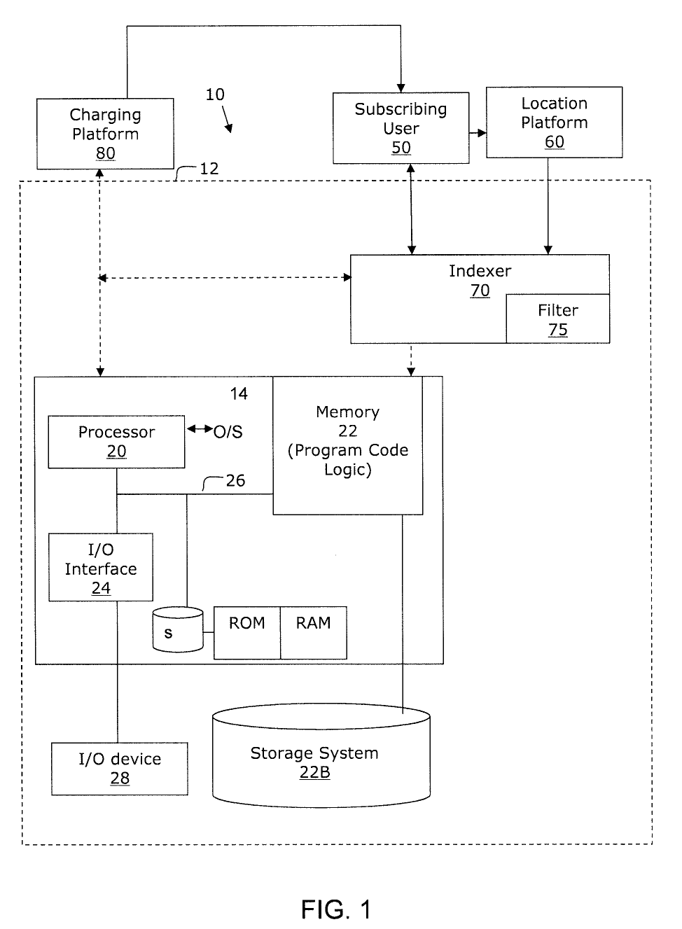

More specifically, FIG. 1 shows an illustrative environment 10 for managing the processes in accordance with the invention. To this extent, the environment 10 includes a server 12 that can perform the processes described herein. In particular, the server 12 includes a computing device 14. The computing device 14 and/or server 12 can be resident on a carrier network infrastructure, content provider infrastructure or other third party service provider (any of which is generally represented in FIG. 1). By using this computing device 14, the network carrier, etc. will not have to make any significant infrastructure investments, as the preexisting infrastructure is utilized with the present invention.

The computing device 14 and/or server 12 includes the computer program code (program code logic) configured to make computing device 14 and/or server 12 operable to perform the services and/or processes described herein. More specifically, an indexer 70 (also referred to as a search and aggregate system) may include the program control as one or computing modules implemented in memory 22A, which is serviced and/or maintained by a service provider such as, for example, a network carrier. The indexer 70, as described herein, can provide the processes of the present invention.

The indexer 70 extends the RSS feed paradigm to deliver information that is dynamic in nature by allowing a user to subscribe to information across multiple RSS and non-RSS feed sources. This allows a user to subscribe to search results and receive new matching information as soon as it becomes available in any one feed. That is, the system and methods of the invention allows the subscribing user 50. to receive an aggregate feed based on search parameters which were created from indexed RSS feeds and non-RSS content, depending on the preferences of the subscribing user 50. This, in turn, allows the subscribing user 50 to receive only the most pertinent information.

More specifically, the indexer 70 is configured to provide an aggregated RSS feed from RSS feeds and non-RSS feeds. To do so, in embodiments, the indexer 70 is configured to search RSS feeds and index the items using the title, link and/or description information of each RSS feed. For non-RSS sources such as, for example, HTML documents, the indexer can index paragraphs, text or structures of the HTML page with a link and description. The index of this information is cached in a central repository, e.g., storage system 22B, for future retrieval based on preferences of the subscribing user 50.

In embodiments, the indexed items can be saved in a centralized location such as, for example, the storage system 22B. Centralizing the indexed RSS items allows for quick searches, but also provides the ability to cache the information for performance. It also provides for storage of the information even after it expires from the original sources. Due to the dynamic nature of information delivered via a RSS feed, the content typically expires and is removed from servers more quickly than other Internet content. This approach also allows the RSS index to retrieve the full content of any content the RSS item references.

In further embodiments, the indexer 70 receives preferences from a subscribing user 50 in order to create a single customized aggregated RSS feed from the index of RSS feeds and non-RSS feeds. For example, the preferences may include search terms and selecting categories which are of interest to the subscribing user 50. The preferences may also include information such as, for example, (i) predefined time periods to receive feeds or certain content, (ii) certain content to be sent to the subscribing user 50 when at specific locations, and (iii) certain content to always be included or excluded, e.g., information on a specific company, etc. The information used to create the aggregated RSS feed from RSS feeds and non-RSS feeds can be prioritized and provided to the subscribing user 50 based on location of the user, blacklist information, past history, active (e.g., user feedback) and passive (e.g., amount of times a user has read a feed) ratings, whitelist information or other user preferences.

The preferences can be saved in a central repository such as, for example, the storage system (database) 22B. Additionally, the storage system (database) 22B can be a credential vault for storing user names and passwords for a user's authenticated feeds. The credential vault may be encrypted and accessed by authorized personnel. This ensures that the preferences and/or profiles of the subscribing user remain secure and private.

In embodiments, the storage system (database) 22B can maintain a persistent user profile for each subscribing user 50. This will allow the following capabilities:
save the custom feeds of each subscribing user 50;
reuse the blacklists and whitelists of the subscribing user 50;
store feedback to enhance the custom feed of the subscribing user 50;
allow the subscribing user 50 to save certain RSS items in a profile for later retrieval even if they expire from the original source; and/or
allow the subscribing user 50 to add a protected RSS feed or web site that has been subscribed to and specify the credentials allowing that information source to be included in the search.

By using the preferences, the indexer 70 can retrieve all accessible web sites, RSS feeds and other types of content (non-RSS feeds) that have been indexed. For example, the indexer 70 can actively and dynamically search the world wide web and RSS feeds based on the search terms, categories and/or other preferences provided by the user for content related to such search terms, categories and/or other preferences. Once content is received and indexed, the indexer 70 can aggregate several of the indexed items, e.g., feeds (and other content) into a single consolidated RSS 2.0 feed that returns information from across the Internet, based on any number of user preferences. For example, the content (RSS feeds) can be provided at certain times or based on certain locations of the subscribing user 50 (as detected by a location platform 60). In embodiments, the indexer 70 can include one or more filters 75, which can filter content based on the preferences, for example. Also, in embodiments, once the feed is created, a unique URL to the user's customized RSS 2.0 feed can then be provided, particularly for HTML pages which were too large to index in their entirety.

As the subscribing user 50 does not have to specify any RSS feed sources and therefore does not miss any relevant information, the subscribing user 50 is assured of obtaining relevant content in a timely manner. For example, by using the preferences, the indexer 70 provides only the most pertinent information to the subscribing user 50 by indexing both RSS and HTML pages into one system. Also, the feed provides the user with access to up-to-date information from across the Internet. The custom feed contents can also change as more information becomes available through the multiple indexed information sources. This removes the need for the user to additionally search for information each day using web search engines because those web sources are also indexed. In other embodiments, the indexer 70 can retrieve information directly from RSS and non-RSS sources without indexing; although, this may be a slower process for the subscribing user 50.

The computing device 14 also includes a processor 20, the memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and a CPU.

The computing device 14 is in communication with the external I/O device/resource 28 and the storage system 22B. For example, the I/O device 28 can comprise any device that enables an individual to interact with the computing device 14 or any device that enables the computing device 14 to communicate with one or more other computing devices using any type of communications link. The external I/O device/resource 28 may be for example, a display, keyboard and pointing device.

In general, the processor 20 executes the computer program code, which is stored in the memory 22A and/or storage system 22B. While executing the computer program code, the processor 20 can read and/or write data to/from memory 22A, storage system 22B, and/or I/O interface 24. The program code executes the processes of the invention. The bus 26 provides a communications link between each of the components in the computing device 14.

The computing device 14 can comprise any general purpose computing article of manufacture capable of executing computer program code installed thereon (e.g., a personal computer, server, handheld device, etc.). However, it is understood that the computing device 14 is only representative of various possible equivalent-computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the server 12 is only illustrative of various types of computer infrastructures for implementing the invention. For example, in embodiments, the server 12 comprises two or more computing devices (e.g., a server cluster) that communicate over any type of communications link, such as a network, a shared memory, or the like, to perform the process described herein. Further, while performing the processes described herein, one or more computing devices on the server 12 can communicate with one or more other computing devices external to the server 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, a charging platform 80 is maintained to provide charging models to charge for services rendered. The charging platform 80 may be maintained, deployed, created and/or serviced by the service provider. The charging platform 80 is designed to generate a charging record for services rendered to the subscriber user 50. The content provider can also be charged for services which are rendered by a network carrier or other service provider. In embodiments, the service provider can calculate an amount to be charged, based on many different considerations and generate the charging record to be sent to the charging platform 80. In turn, the charging platform 80 can generate an invoice and/or deduct a usage charge from an account of the subscriber.

In embodiments, the invention provides a business method that performs the steps of the invention on a subscription, advertising, and/or fee basis. That is, a service provider, such as a Solution Integrator or location based service, could offer to perform the processes described herein. In this case, the service provider can create, maintain, deploy, support, etc., the computer infrastructure that performs the process steps of the invention for one or more customers. The customers may be, for example, a mobile user or a third party requesting content information. In return, the service provider can receive payment from the customer(s) under a subscription and/or fee agreement and/or the service provider can receive payment from the sale of advertising content to one or more third parties.

### Exemplary Embodiments Implemented on the Computing Infrastructure

The present invention contemplates many different customization and options. These customizations and options can stand-alone or be combined in any desired configuration. Also, each of the customizations and options can be provided by a service provider, content provider, network carrier or any combination thereof, using their own infrastructures and environments. The service provider, content provider, network carrier or any combination thereof can charge separately, together or any combination thereof for providing the customizations and options. Several different embodiments are discussed below.

In embodiments, even though the subscribing user 50 receives a single feed of customized information, it is expected that some irrelevant information may still be received from the system of the present invention. Accordingly, to ensure that irrelevant or extraneous information is not provided to the subscribing user 50, user feedback can be provided to fine tune the user's customized feed. This can be done by way of one or more preferences or feedback which is provided to the filter 75.

In one contemplated embodiment, passive feedback is collected by the indexer 70 monitoring which RSS items are selected, accessed and/or read by the subscribing user 50. Active feedback is also contemplated by collecting feedback from the subscribing user 50. This can be accomplished by having each entry returned to include a link to submit feedback. The subscribing user 50 could mark an item as a good match or irrelevant. In this embodiment, a numeric sliding scale could help the user identify the relevance of a match, e.g., 10 being a perfect match and 0 being a bad match. Both types of feedback are incorporated back into the system to affect the customized feed and enhance future results using, for example, the filter 75 of the present invention.

In additional embodiments, a priority list can be used when creating a customized RSS feed. This allows the subscribing user 50 to indicate a particular information source such as a website or RSS feed to mark as high priority. The search logic of the indexer 70, for example, can use this information to return matching items from those sources above other matches from a non-priority site. In one example, a site higher on the priority list would indicate a higher priority than other sites lower on the priority list. In still additional embodiments, a feed priority list can be turned into a whitelist by instructing the customized RSS feed to only return results from the priority list.

In still further embodiments, a priority list may also contain a feed that requires authentication along with the user's personal credentials (username/password). This RSS feed would be accessed and processed in addition to the shared information from the indexer 70. Any information matching the customized RSS criteria would be prioritized like any other source on the priority list.

In still additional embodiments, in addition to adding priority sites the subscribing user 50 can utilize a blacklist. The blacklist will instruct the system of the invention to exclude any results from an information source located on the blacklist.

In yet additional embodiments, at the time of indexing, any location referenced in the information article is also indexed as a searchable term. This allows the subscribing user 50 to enable their customized search to be location aware if their device supports Location Based Services. This allows information related to their current location to be prioritized or visually differentiated in their results. The location based services can be obtained from a location platform 60.

### Exemplary System Context

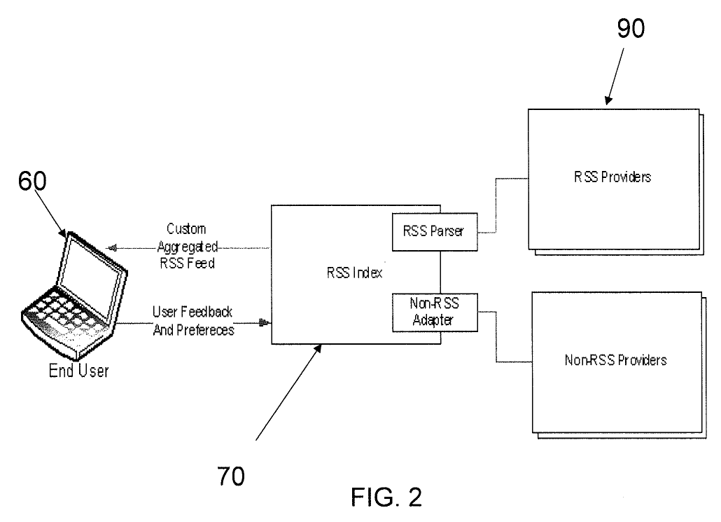

FIG. 2 is a high level system context for implementing processes in accordance with the invention More specifically, FIG. 2 shows a system context and relationships between the subscribing user 50, the indexer 70 and the information providers 90. In particular, the indexer 70 receives user feedback and preference information. In one optional embodiment, using this information, the indexer 70 retrieves relevant information from both RSS and non-RSS providers 90 by parsing such information using, for example, an RSS parser and non-RSS adapter. Relevant information is indexed and, in embodiments, centrally saved for future retrieval. The relevant information is provided to the subscribing user 50 as a custom aggregated RSS feed.

In another embodiment, the indexer 70 can actively retrieve items (e.g., links and descriptions) from both RSS and non-RSS providers 90 by parsing such information using, for example, an RSS parser and non-RSS adapter. The items are then indexed and, in embodiments, centrally saved for future retrieval. The indexed information can then be searched to obtained relevant information based on the preferences of the user. This relevant information is then provided to the subscribing user 50 as a custom aggregated RSS feed based.

In embodiments, the non-RSS formatted Internet information sources are indexed. Smaller amounts of information may be stored as RSS items, but larger pages and documents are indexed like a typical search engine indexing services. This allows for dynamic summary snippet to be returned for each result in a set of search results as a RSS item in the user's customized feed with a link to the full page or document. For example, the RSS feed can include URLs of web pages which were too large to be downloaded and saved. Also, in embodiments, the indexed information can be maintained at the RSS item level without having to keep the entire feed content grouped together. This allows the user's custom aggregated feed to be comprised of RSS items from multiple feeds that best match the user's criteria. The matching RSS items from across multiple sources are assembled into this custom feed.

Also, as discussed above, centralizing the RSS items index allows for quick searches, but also provides the ability to cache the information for performance. It also provides the advantage of storing the information even after it expires from the original sources. This also allows the indexer to retrieve the full content of any content the RSS item references.

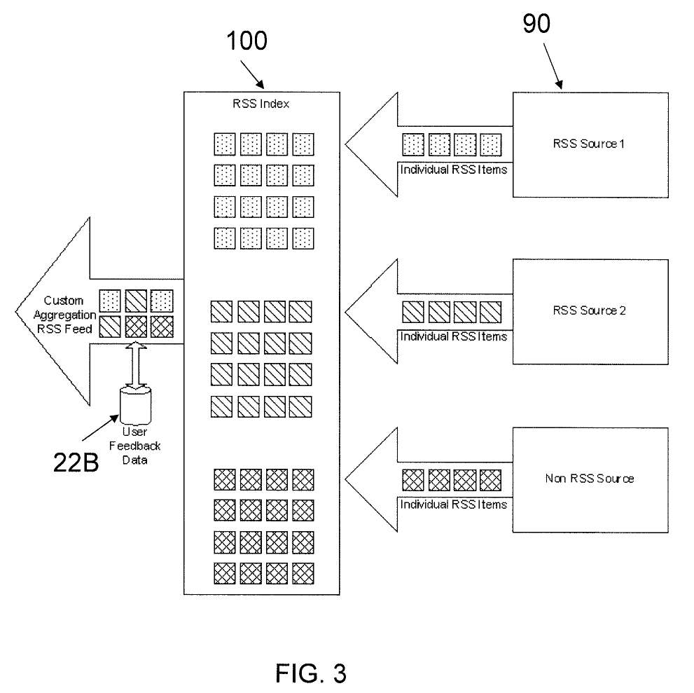

FIG. 3 is a high level schematic showing RSS indexing of multiple of RSS items from RSS and non-RSS sources in accordance with aspects of the present invention. More specifically, FIG. 3 represents the RSS indexing of multiple RSS items from RSS and non-RSS sources. The information is stored at the RSS item level allowing the system to return a custom aggregation of RSS items to the end user.

In particular, FIG. 3 is representative of an RSS index 100 receiving individual RSS and non-RSS information from different sources 90. The RSS index 100 (which may be part of the indexer 70 of FIG. 1) will index the individual RSS and non-RSS information according to, for example, content or source. This is represented by the different hash markings on each of the pieces of representative information. In accordance with user preferences and feedback information, which may be stored in the user feedback database (e.g., storage system 22B), the RSS index 100 will provide a customized aggregate RSS feed to the subscribing user.

Still referring to FIG. 3, in embodiments, the indexer users a spider and creates a collection based from the spiders returns. In implementation, this can create two separate collections: the first collection is for non-RSS sources and the second is for RSS sources. The indexer has the option to create a custom daily feed or send the results back to the subscribing user.

A basic flow for RSS searching and aggregation after the formation of collections can include, for example, duplicate removal and user feedback information, amongst other combination of features described herein. As to the duplicate removal process, during the spider search process, the spider can determine if the link is an RSS feed by parsing the page and determining if the feed is RSS based. Simply, an RSS feed contains XMI stating that it is in the RSS format. The following example shows the starting tag for a RSS feed:

<?xml version=“1.0”?><!DOCTYPE rss PUBLIC “-//Netscape
Communications//DTD RSS 0.91//EN”
“http://my.netscape.com/publish/formats/rss-0.91.dtd”><rss
version=“0.91”> <channel> <title>The Neal Boortz Show</title>
<link>http://boortz.com</link> <description>The world-famous
Internet site of the Nationally Syndicated talk radio host Neal
Boortz!</description> <language>en-us</language>

As an illustrative, non-limiting example, each item in the RSS feed can be displayed as follows:

<item>
<title>THE VICK LETTERS</title>
<link>http://boortz.com/nuze/200712/12142007.html#vick</link>
<description>

To begin your reading pleasure for today, here are some links to copies of letters written to Judge Henry Hudson by or on behalf of Michael Vick; part of the effort to get leniency for Vick at his sentencing earlier this week . . .
</description></item>

During the duplicate removal process, the indexer can check and compare links on the page to links on other pages. To speed duplicate detection, the check is first performed using the RSS <link>item before scanning the entire content.

The active and passive feedback of the subscribing user, described above, can be used to enhance the future results of the custom feed. The feedback, stored in the user feedback database (user feedback system), can also be used to enhance the custom feeds for other users. For example, if a particular result is clicked much more often than other items (passive feedback) or a particular result is rated positive by multiple users or a single user (active feedback), it will be prioritized for future users. This can be tracked by adding an element to RSS items in the search index to track the number of views and average feedback score.

### Exemplary Processes

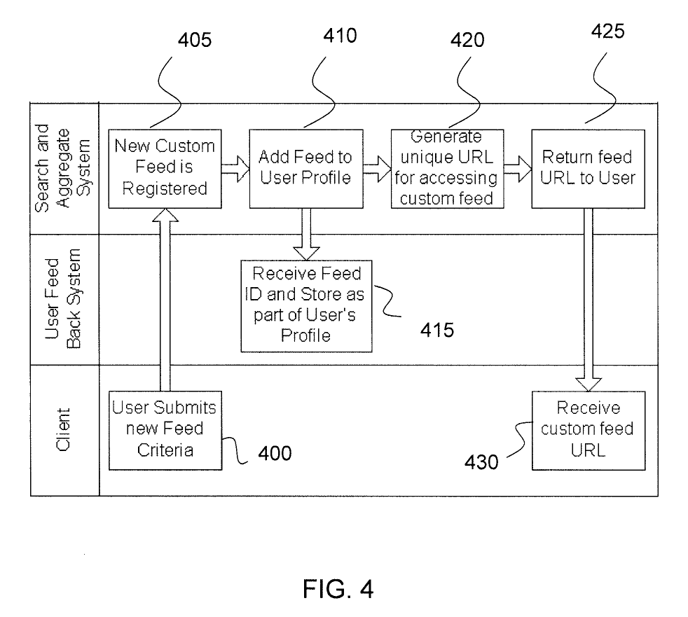

FIGS. 4-6 illustrate exemplary processes in accordance with the present invention. The steps of FIGS. 4-6 may be implemented on the computer infrastructure of FIG. 1 and the systems shown in FIGS. 2 and 3, for example. The swim lane diagrams (flow diagrams) in FIGS. 4-6 may be illustrative of the architecture, functionality, and operation of possible implementations of systems, methods and computer program products according to various embodiments of the present invention. In this regard, each process may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the flow diagrams, and combinations of the flow diagrams illustrations can be implemented by special purpose hardware-based systems that perform the specified functions or acts, or combinations of special purpose hardware and computer instructions and/or software, as described above.

Additionally, the invention can take the form of an entirely hardware embodiment, an entirely software embodiment or an embodiment containing both hardware and software elements. Software includes but is not limited to firmware, resident software, microcode, etc. Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

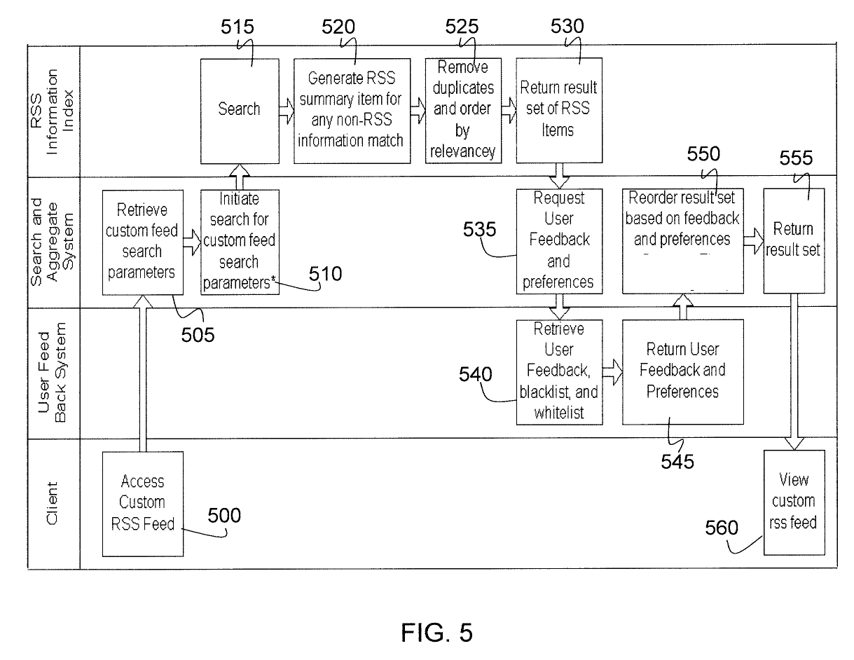

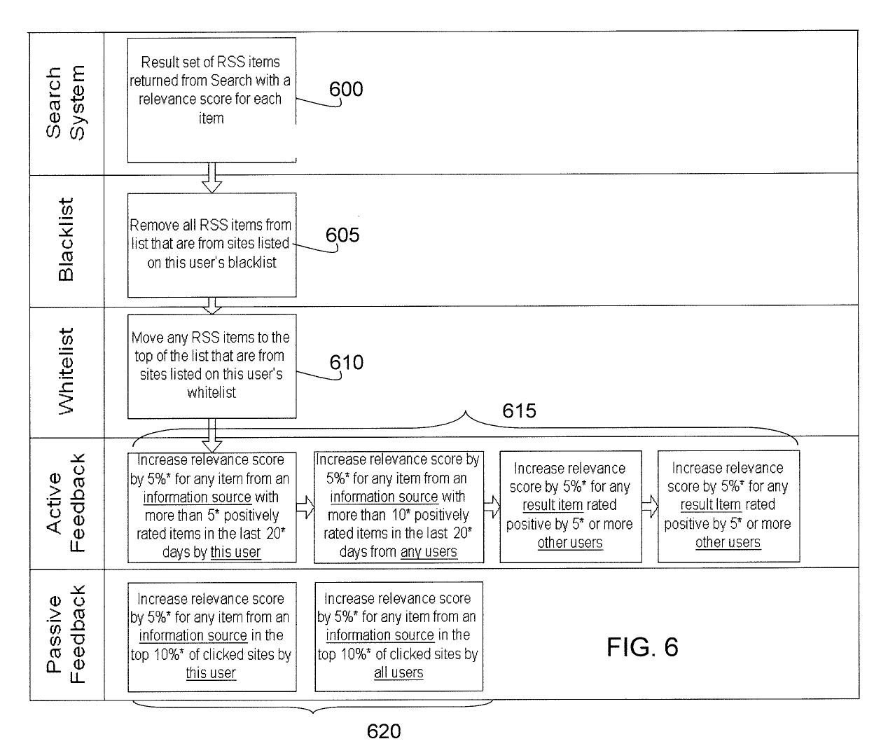

In embodiments, the invention is separated into three different flows. For example, the flow of FIG. 4 shows a swim lane diagram depicting a process of creating a custom feed in accordance with aspects of the present invention. FIG. 5 is a swim lane diagram depicting a process of accessing a custom feed and built dynamically in accordance with aspects of the present invention. FIG. 6 is a swim lane diagram depicting a process of reordering search results based on various criteria in accordance with aspects of the present invention.

In the flow of FIG. 4, three roles are shown: a client (subscribing user), a user feedback system, and a search and aggregate system (indexer). At step 400, the client submits a new feed criteria. This may include, for example, a search criteria, requested content or feeds and/or other preferences. At step 405, the indexer (search and aggregate system) registers the new custom feed. At step 410, the indexer adds the feed to the user profile and, at step 415, the user feedback system receives the feed ID and stores it as part of the user's (client's) profile. At step 420, the indexer will generate a unique URL for accessing the custom feed. At step 425, the indexer will feed the URL to the client. At step 430, the client will receive the custom feed URL. The Feed ID representing all the setup data entered by the user and resulting custom feed URL is, in embodiments, persistent beyond a single use. Accordingly, the information returned each time a user accesses the URL daily, weekly, etc. is updated based on the latest information retrieved from all the RSS and non-RSS sources and feedback data.

Referring to FIG. 5, four roles are shown: a client (subscribing user), a user feedback system, and the indexer shown as a search and aggregate system and RSS information index. It should be understood by those of skill in the art that the search and aggregate system and RSS information index can be a single or separate module and, if separate modules, can reside on one or more computing infrastructures associated with one or more providers, for example.

In embodiments, at step 500, the client accesses a custom RSS feed. At step 505, the search and aggregate system retrieves the custom feed search parameters. At step 5 10, the search and aggregate system initiates the search associated with the custom feed search parameters. At step 515, the RSS information index begins the search and, at step 520, generates an RSS summary item for any non-RSS information match. At step 525, the RSS information index removes the duplicates and, in embodiments, orders the results by relevancy, e.g., perhaps by priority. At step 530, the RSS information index returns the result set of the RSS items and, at step 535, the search and aggregate system requests user feedback and preferences. Step 535 or portions thereof may be an optional step. At step 540, the user feedback system retrieves the user feedback which may include, for example, whitelist and blacklist information amongst other feedback as discussed herein. At step 545, the user feedback system returns the user feedback and preferences. At step 550, the search and aggregate system reorders the result set based on the feedback and preferences. Step 550 is described in more detail in the swim lane diagram of FIG. 6. At step 555, the search and aggregate system returns the result. At step 560, the client can view the custom RSS feed (e.g., on a display of a device).

In FIG. 6, a process is shown to reorder results based on the user's preferences. For example, FIG. 6 shows the use of passive feedback, active feedback, backlist and whitelist preferences. At step 600, the search system (search and aggregate system) obtains a result set of RSS items returned from search with, for example, a relevancy score for each item as already discussed. At step 605, blacklisted RSS items are removed from the list. At step 610, whitelisted RSS items are moved to the top of the list. At collective step 615, a relevance score can be increased or decreased based on positive or negative rated items using an active feedback. For example, the relevance score can be increased by a predefined percentage such as, for example, 5%, if the items are rated positive by (i) the present user, (ii) any user or (iii) other defined users. At collective step 620, a relevance score can be increased or decreased based on positive or negative rated items using a passive feedback. For example, the relevance score can be increased by a predefined percentage such as, for example, 5%, if the items are rated positive by (i) the present user or (ii) all users.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. While the invention has been described in terms of embodiments, those skilled in the art will recognize that the invention can be practiced with modifications and in the spirit and scope of the appended claims.

What is claimed is:

1. A method implemented on a computing infrastructure comprising:
indexing items from at least one of multiple RSS sources and non-RSS sources;
aggregating two or more of the items from the indexed items associated with one or more user preferences; and
sending an aggregated RSS feed to a user which includes the aggregated two or more of the items associated with the one or more user preferences.

2. The method of claim 1, further comprising caching the indexed items from the RSS source and non-RSS source on a central repository.

3. The method of claim 2, wherein the caching provides for storage of information even after it expires from its original sources.

4. The method of claim 1, further comprising reordering the aggregated two or more of the items in the aggregated RSS feed based on whitelist information provided by the user.

5. The method of claim 1, further comprising removing aggregated two or more of the items in the aggregated RSS feed based on blacklist information provided by the user.

6. The method of claim 1, further comprising scoring the aggregated two or more of the items in the aggregated RSS feed based on active or passive feedback.

7. The method of claim 1, further comprising actively searching the RSS source and non-RSS source on a predetermined basis and indexing search results to generate the indexed items.

8. The method of claim 1, further comprising providing the aggregated two or more of the items in the aggregated RSS feed to the user based on a location of the user.

9. The method of claim 1, further comprising parsing the at least one of multiple RSS sources and non-RSS sources in order to obtain information of the one or more items for storage and later retrieval, wherein the information is at least one of a title, link and description of an RSS feed.

10. The method of claim 1, further comprising parsing the non-RSS sources for information including URL and text or structure, wherein the aggregated RSS feed includes the URL and text.

11. The method of claim 1, further comprising generating a unique URL for accessing the aggregated RSS feed, wherein a feed ID representing all setup data entered by the user and resulting feed URL is persistent beyond a single use such that information returned each time the user accesses the unique URL is updated based on latest information retrieved from the at least one of multiple RSS sources and non-RSS sources and feedback data.

12. The method of claim 1, further comprising storing the preferences and profile of the user.

13. The method of claim 1, further comprising at least one of:
saving custom feeds of the user;
reusing blacklists and whitelists of the user;
storing feedback to enhance the custom feeds of the user;
allowing the user to save certain RSS items in a profile for later retrieval even if they expire from an original source; and
allowing the user to add a protected RSS feed or web site that has been subscribed to and specify credentials allowing the information source to be included in a search.

14. The method of claim 1, wherein the computing infrastructure is at least one of maintained, deployed, created and supported by a service provider.

15. The method of claim 1, wherein the steps are provided on a software component, a hardware component or a combination of the software component and the hardware component.

16. A computer program product comprising a computer usable storage medium having readable program code tangibly embodied in the storage medium, the computer program product being operable to:
receive and store user preferences for obtaining content on one or more RSS sources and non-RSS sources;
retrieve items from the one or more RSS sources and non-RSS sources;
aggregate the items from the one or more RSS sources and non-RSS sources associated with the user preferences; and
send an aggregated RSS feed to the user of the aggregated items from the one or more RSS sources and non-RSS sources.

17. The computer program product of claim 16, wherein the computer program product is further operable to index the retrieved items and store the indexed items on a central repository for later retrieval, the index including at least one of a description and a link of the retrieved items.

18. The computer program product of claim 16, wherein the computer program product is further operable to at least one of:
reorder the items in the aggregated RSS feed based on whitelist information provided by the user;
remove the items in the aggregated RSS feed based on blacklist information provided by the user; and
score the items in the aggregated RSS feed based on at least one of an active and passive feedback.

19. The computer program product of claim 16, wherein the computer program product is further operable to provide the aggregated items in the aggregated RSS feed based to the user based on a location of the user.

20. The computer program product of claim 16, wherein the computer program product is further operable to parse the one or more RSS sources and non-RSS sources in order to obtain information of the items for storage and later retrieval.

21. The computer program product of claim 16, wherein the computer program product is further operable to:
store the preferences and profile of the user;
save custom feeds of the user;
reuse blacklists and whitelists of the user;
store feedback to enhance the custom feeds of the user;
allow the user to save certain RSS items in a profile for later retrieval even if they expire from an original source; and
allow the user to add a protected RSS feed or web site that has been subscribed to and specify credentials allowing the information source to be included in a search.

22. A system implemented on a computer infrastructure having at least hardware components or a combination of software components and the hardware components operable to:
store user preferences for obtaining content on one or more RSS sources and non-RSS sources;
retrieve items from the one or more RSS sources and non-RSS sources;
index the retrieved items;
store the index of items for future retrieval;
aggregate the indexed items associated with user preferences; and
send an aggregated RSS feed to the user of the aggregated indexed items from the one or more RSS sources and non-RSS sources based on the user preferences.

23. The system of claim 22, wherein the computer infrastructure is further operable to encrypt the location information prior to sending to the subscribing user and send a key to the subscribing user to decrypt the encrypted location information.

24. The system of claim 22, wherein the computer infrastructure is further operable to at least one of:
save custom feeds of each user;
reuse blacklists and whitelists of the user;
store feedback to enhance the custom feeds of the user;
allow the user to save certain RSS items in a profile for later retrieval even if they expire from an original source; and
allow the user to add a protected RSS feed or web site that has been subscribed to and specify credentials allowing the information source to be included in a search.

25. The system of claim 22, wherein the computer program product is further operable to parse the one or more RSS sources and non-RSS sources in order to obtain information of the items for storage and later retrieval, wherein the information is a link and description of an RSS feed or a URL and text of a non-RSS source.
